(19) United States
(12) Patent Application Publication
(10) Pub. No.: US 2008/0099274 A1
(43) Pub. Date: May 1, 2008

(54) Sound Attenuation Enclosure

(76) Inventor: Robert Vaughan Seel, Dublin, OH (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/554,759

(22) Filed: Oct. 31, 2006

(51) Int. Cl. H02K 5/24

(52) U.S. Cl. 181/202

(57) ABSTRACT

A sound attenuation enclosure comprising a plurality of panels positioned side by side to one another and supported on a plurality of columns wherein each panel is positioned in spaced relation to an adjacent panel to allow airflow in and out of the enclosure. The panels and columns may have an enclosed inner chamber filled with a sound retardant material.

### FIELD OF THE INVENTION

This invention relates to devices used to attenuate sound emanating from mechanical or electro-mechanical operating systems where noise, sound or vibration are a consideration for the operation of such systems.

### BACKGROUND OF THE INVENTION

An ongoing problem associated with mechanical and electro-mechanical operating systems is the level of noise such systems generate. With the continuous technical advances in the fields of metallurgy, electrical and mechanical engineering, manufacturers of equipment are able to minimize the physical dimensions of equipment including the thickness and mass of equipment components. Sound and improved efficiency/performance often cause conflicting results. These changes often result in increased noise pollution levels. Examples of such operating systems include, but are not limited to, HVAC units, pool pumps, gas manifolds, emergency storm generators and sump pumps.

Equipment manufacturers often are limited to installing sound blankets or lining the operating system with fiber wool to reduce the noise level emanating from the operating system. Similar principles have been adopted by the gas turbine and automotive industry using combinations of fiber, acoustic foams and composite metal combinations to address the various sound issues. Although sound cancellation schemes have been proposed, no solution has been found to satisfactorily address the broad-spectrum noise cancellation signature of a mechanical or electro-mechanical operating system. The sound blankets placed over gas valves, motors, compressor and various operating systems and provide minimal sound reduction.

Such attempts to meet consumer needs have encountered manufacturing and performance issues, produced minimum reliability performance and in some cases health hazards. As an example, fiber glass/wool materials can be a nesting area for rodents. These materials also retain moisture, which causes fungal/bacteria growth. The sound blankets typically have a vinyl jacket filled with a fiberglass material commonly known as R-19. In addition, the blanket contacts the operating system, which can reduce the overall performance and life of the operating system. The blanket acts as an insulating jacket that generates heat. Elevated temperatures with respect to a normal operating temperature places stress on components causing system failures.

Sound abatement enclosures are available for sound abatement of larger industrial operating systems. However, these enclosures are typically custom-designed for a specific application of an operating system. As such these enclosures can be extremely expensive and/or cost prohibitive. Accordingly, there remains significant room for improvement in low cost noise abatement for electrical and mechanical systems especially where the system is exposed to the outdoor environment.

### SUMMARY OF THE INVENTION

The present invention for a sound attenuation enclosure comprises a plurality of panels that are supported and arranged with respect to one another to form an enclosure. At least two of the panels are supported side by side and in spaced relation to one another and one or more of these two panels have an inner chamber filled with sound retardant material. In one embodiment the least two panels are supported side by side such that the panels overlap one another.

In another embodiment each of the plurality of panels has an inner enclosed chamber filled with a sound retardant material. The panels are supported side by side so that each panel is positioned in spaced relation to an adjacent panel, and the plurality of panels are arranged to form an enclosure. In addition, the panels are arranged so that a top section or bottom section of each panel overlaps a top section or bottom section of an adjacent panel. The overlapping of the panels provides an additional barrier to emanating sound pressure waves, as opposed when panels are aligned side by side but are not overlapping. A surface of the panels that form an inner surface of the enclosure may comprise a series of adjacent cavities and protrusions, which cause viscous losses as sound pressure waves move in and out of the cavities. In addition, or alternatively the inner surface of the enclosure may be lined with sound attenuating materials that form a textured service to have the same effect as the series of cavities on sound pressure waves.

The enclosure, and components of the enclosure, is transportable in the sense that all the components can be transported to a desired site and assembled to form the enclosure. Accordingly, the enclosure includes a means, associated with the first end and the second end of each panel, for supporting the plurality of panels wherein each of the panels is positioned beside another panel forming an enclosure wherein the panels are detachable from the enclosure so the enclosure can be transported. One embodiment includes a plurality of support columns that support the panels. Each of the columns includes one or more recesses within which a first end or second end of each panel is placed in mating relationship. In one embodiment, the columns are vertically disposed and the recess is an elongated, vertically disposed channel. The panels are horizontally disposed and a first end and second end of each panel is positioned in mating relationship with a recess in a column thereby supporting the panels and forming the enclosure. The panels and columns can be easily detached from one another making the enclosure and its components transportable.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a perspective view of a first embodiment of the enclosure.

FIG. 2 is a perspective sectional view of some panels of the enclosure.

FIG. 3 is an exploded perspective view of the enclosure.

FIG. 4 is an end sectional view of some panels of the enclosure of the first embodiment.

FIG. 5 is an exploded perspective view of a second embodiment of the enclosure.

FIG. 6 is a perspective view of panels being attached to a support column.

FIG. 7 is an end sectional view of some panels of the enclosure of the second embodiment.

FIG. 8A is a perspective view of a third embodiment of the enclosure.

FIG. 8B is an end sectional view of some of the panels of the third embodiment taken along line B-B in FIG. 8A.

FIG. 9 is a side view of some panels of the enclosure.

FIG. 10 is an exploded perspective view of the third embodiment of the enclosure.

FIG. 11 is a top view of a corner of the enclosure in FIG. 10.

FIG. 12 is an exploded perspective view of the enclosure with a support rod.

FIG. 13 is a perspective view of a cowling.

FIG. 14 is a sectional view taken along line 14-14 in FIG. 13.

FIG. 15 is an exploded perspective view of a grommet being installed in an enclosure.

FIG. 16 is a perspective view of a grommet installed in a panel.

### DETAILED DESCRIPTION OF THE DRAWINGS

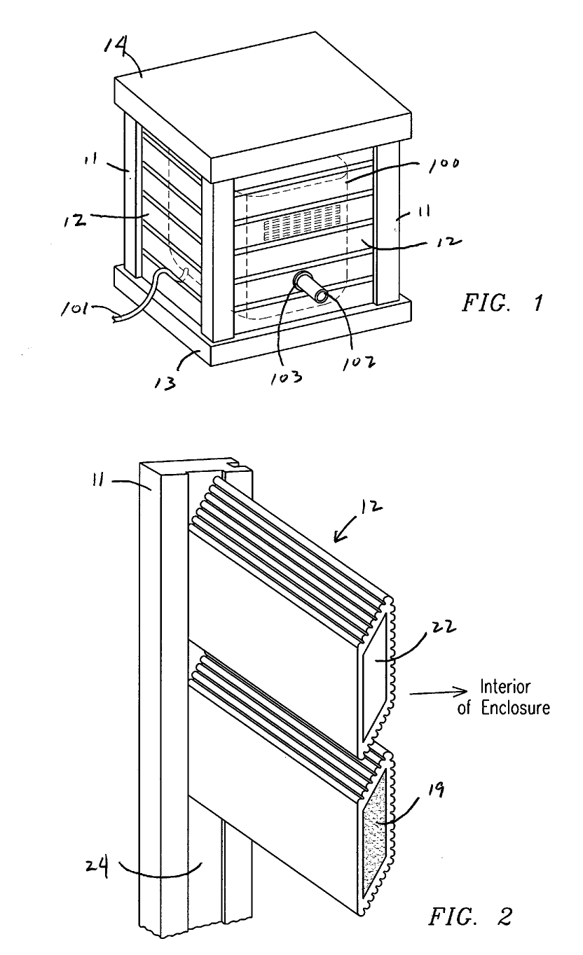

A first embodiment of the present invention for a sound attenuation enclosure is illustrated in FIGS. 1 through 4. The enclosure 10 comprises a plurality of sound insulating panels 12 attached to and supported on support columns 11. One or more of the panels 12 has a shell-like, or tubular, configuration having an inner chamber 22 filled with a sound retardant material 19. The columns 11 may also have a similar configuration for retaining the sound retardant material 19.

Various sound retardant materials are acceptable, including, but not limited to, rubber, polymer foam, water, gravel, sand, or other dense materials used for sound attenuation. In some instances, the panels 12 and/or columns 11 may not contain the sound retardant material, and the components remain hollow. Alternatively, the panels 12 may be fabricated as a solid piece of sound retardant material, and not have a chamber 22.

The panels 12 and columns 11, and those similar components described in all embodiments discussed herein, are preferably fabricated from extrusion of known materials including aluminum, steel, rubber (neoprene, polyisoprene, natural rubber, polyurethane, viton, nitrile, silicon etc.) or a plastic material (polyvinylchloride, polyethylene, polystyrene, nylon etc.). However, other methods such as blow molding, slip casting, pressing and injection molding and materials used with such methods may be used to practice the disclosed invention.

In addition, all components described in each of the embodiments may be designed so that the enclosure, including its components, is transportable to and assembled at a desired site. If necessary, the enclosure can be disassembled, and the components moved to another site or stored. The enclosure 10 and its components may range in dimensions depending on the nature of the device to be covered. The enclosure 10 can be used to cover household devices such as pool pumps, air condition units, portable generators or any other items that generates sound at an unacceptable noise level. In addition, the enclosure 10 may have commercial applications are where a temporary sound barriers is required to lessen noise impact on the surrounding area, for example military field generators and transformers or building construction/improvement sites.

The dimensions of each of the embodiments described herein will vary in part according to the size of the operating system enclosed and the desired level of noise abatement to be achieved. For example, for a typical household HVAC unit, the interior surface of the enclosure 10 would be spaced from a surface of the HVAC about two inches to about four inches; however, the distance the enclosure may be greater or less depending in part on the size of the HVAC unit. In addition, the chamber 22 may vary in size according to the materials used to fabricate the components of the enclosure, the type of filler and the sound level generated by the HVAC unit. For example, the chamber may be about 7 mm to 9 mm thick, and wall thickness of the panel 12 may be about 3 mm to about 4 mm thick. If the panels 12 are fabricated as a solid mass loaded rubber or aerated cement/rubber mix the wall thickness may be about 10 mm to about 12 mm thick. The applications relating to larger operating devices, and/or devices that create a higher level of sound of 80 decibels or higher, the wall thickness may be about 2.5″ to about 4″.

Typical household HVAC units produce noise/sound at levels typically ranging from about 74 decibels to about 78 decibels. The enclosure 10 disclosed herein, at least with respect to use with HVAC units, may reduce the noise level emanating from an enclosed operating system by 15 decibels or to around 60 decibels.

The ends of panels 12 are closed in order to retain the sound retardant material 19 within the chamber 22. For example, if the panels 12 are formed from extrusion of a moldable material, one or both ends may be open after extrusion. An end cap (not shown) can be welded on one end of the panel 12 so that the sound retardant material can be placed in the chamber 12 from an open end, which is closed by welding another end cap on the panel 22. In an injection molding process an aperture may be formed on the panel 12, preferably on one end of the panel 12, and the sound retardant material 19 may be poured into the chamber 22 and a plug (not shown) is inserted in the aperture to encase the sound retardant material 19, within the chamber 22.

With respect to the first embodiment, each of the panels 12 is supported on the columns 11 in such a manner that each panel 12 is positioned in spaced relation to an adjacent consecutive panel 12 forming a gap 104 between the panels 12. In this manner, the enclosure 10 is ventilated for dissipation of heat generated by an enclosed mechanical or electro-mechanical operating system.

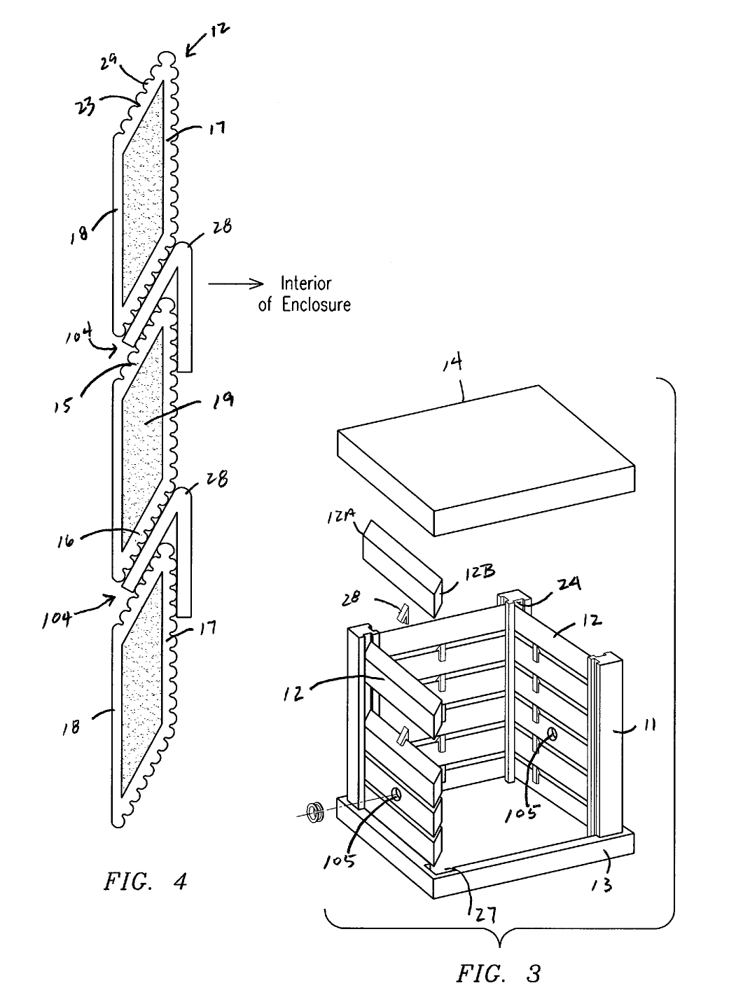

With respect to FIGS. 2 and 3, the panels 12 have a top section 15 and a bottom section 16. Two side sections 17 and 18 are disposed between top section 15 and bottom section 16. The side section 17 faces an interior of the enclosure 10 and side section 18 faces an exterior of the enclosure 10. Side sections 17 on the panels 12 form an interior surface of the enclosure 10. The top section 15 and bottom section 16 are parallel to each other and are inclined at an angle, preferably 45°, with respect to the side sections 17 and 18. In this manner, consecutive adjacent panels 12 overlap one another. Although the panels 12 are spaced apart, the overlap of the panels provides a physical obstruction to sound pressure waves that may emanate from an enclosed operating device.

The surface of the panels 12 facing an interior of the enclosure 10 may be textured to further enhance the sound retarding effects of the enclosure 10. For example, as shown in FIGS. 2 and 3, the surface of the panels 12 includes a series of adjacent cavities 23 and protrusions 29 that can be formed during extrusion. The example shown in FIG. 1 has elongated uniformly configured cavities and ridges. Other textures, such as a dimple configuration, a spike configuration may be effective for sound attenuation. The type of texture may be governed by various factors such as the material composing the panels, the method of manufacture (injection molding, extrusion, slip casting etc.) or level of sound attenuation desired. In addition, or alternatively, strips of sound attenuating materials such as acoustic foam may be affixed to and spaced apart along the inside surface of the panels 12 forming the adjacent series of cavities and protrusions. By providing a texture to the surface, the cavities 23 cause viscous losses to the sound pressure waves moving in and out of the cavities 23.

With respect to FIGS. 2 and 3, the connection of the panels 12 to the columns 11 is illustrated. In the embodiment shown in FIGS. 1 through 4, the enclosure 10 includes four columns 11 secured to a base 13. The base 13 is rectangular and has a notch 27 disposed in each of the four corners for receiving a column 11. While this embodiment has a rectangular configuration, the invention is not so limited and may include any type of configuration necessary to form an enclosure. Each of the columns 11 includes an elongated channel 24 within which a first end 12A and second end 12B of the panels 12 are inserted. The columns 11 are vertically disposed and each end 12A and 12B of the panel 12 is inserted within a channel 24 on a respective column 11. The panels 12 are disposed horizontally between the columns 11, and a spacer 28 is positioned between adjacent panels 12 so the adjacent panels 12 are positioned in spaced relation to one another.

Accordingly, in practice the columns 11 and panels 12 are transported to a desired location. The columns 11 are positioned around the device to be enclosed. The ends 12A and 12B of a panel 12 are inserted into the channel 14 preferably by sliding the panel 12 from the top of the column to the bottom of the column 11. Another panel 12 is then placed in position above or beside the first panel with the spacer 28 disposed there between so the panels 12 are spaced apart. This is repeated until the enclosure 10 is formed.

The base 13 is not required to form the enclosure 10. That is, the columns 11 may be free standing without the aid of the base 13. In addition, the method or means for securing the panels 12 to the columns 11 is not limited to the elongated channel 24, but may include other securing means. For example, the columns may have holes spaced vertically spaced on the column for receiving the ends of the panels 12. Alternatively, fastening mechanism as nails, bolts, clamps etc. may be used to secure the panels 12 to columns 11.

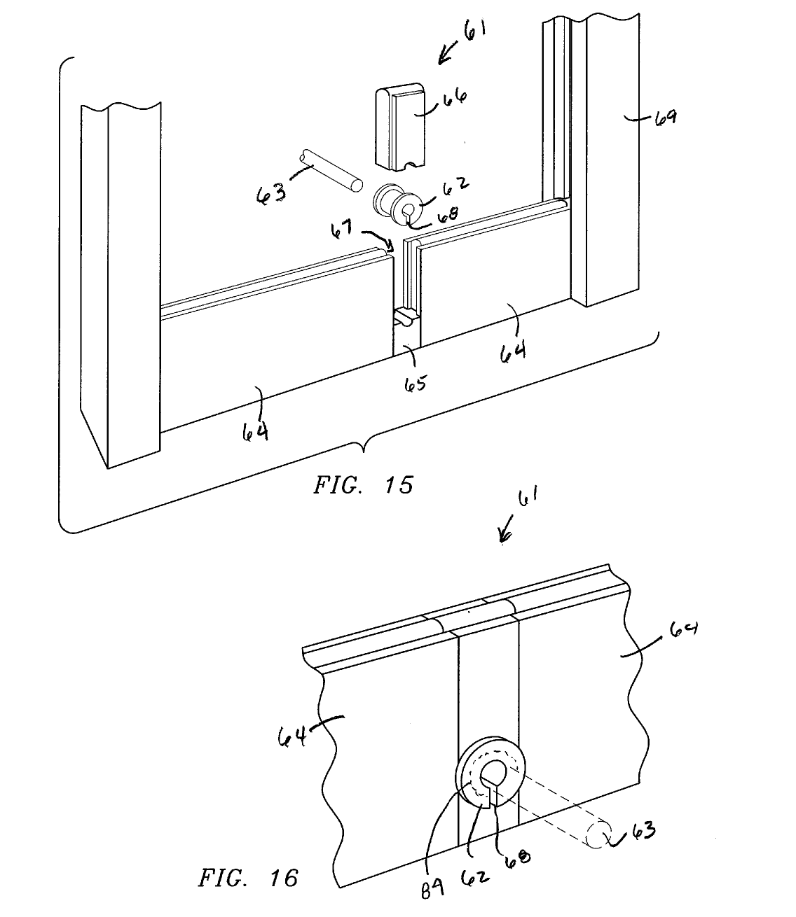

In addition, a cover 14 may be provided to further attenuate sound and protect an enclosed system from the environment. The cover 14 may take the solid configuration shown in FIG. 1, or include a wire mesh screen, ventilation slots or the like to permit ventilation of air and heat dissipation. In some circumstances, the operating device, such as an HVAC unit, within the enclosure may require, or generate a significant amount of airflow in and out of the enclosure. A cowling 81, as shown in FIGS. 15 and 16 may be used with the enclosure 10. The cowling 81 has a curved surface 82 that bends outward with respect to an interior of the enclosure 10. The cowling 81 or cover 14 may have an enclosed inner chamber 83 that is filled with a sound retardant material 19. In addition, the surface 82 of the cowling 81 may be textured include the previously described cavities 23 and protrusions 29 for attenuating sound emanating from device within the enclosure 10.

As shown in FIGS. 1 and 3, the operating system 100 within the enclosure 10 may have parts such as a chord 101 or pipe 102 that protrude from the enclosure 10. In as much as the panels 12 are spaced apart, the chord 101 may extend through the gap 104 between consecutive panels 12. In addition, the enclosure 10 may have one or more apertures 105 through which a pipe 102 may extend. The panels 12 may be prefabricated with the aperture 105 formed in one or more of the panels 12; or, if the panels 12 are fabricated as a solid integral piece of sound retardant material 19 the aperture 105 may be drilled in a panel 12 on site. In either case, the pipe 102 may have to be detached from the operating system 100, the panel 12 with the aperture 105 is aligned with attachment site of the pipe 105 to the operating system 100 and the pipe 102 is reinstalled.

A grommet 103 is then inserted in the aperture 105 between pipe 105 and panel 12 sealing the interface between the pipe 102 and the enclosure 10. In addition, or alternatively, a grommet assembly 91 described below, and shown in FIGS. 13 and 14, may be used to install the grommet 105. As described below in more detail, the grommet 103 preferably has a slit, and is sufficiently flexible to be opened, wrapped around the pipe 102 and popped into the aperture 105.

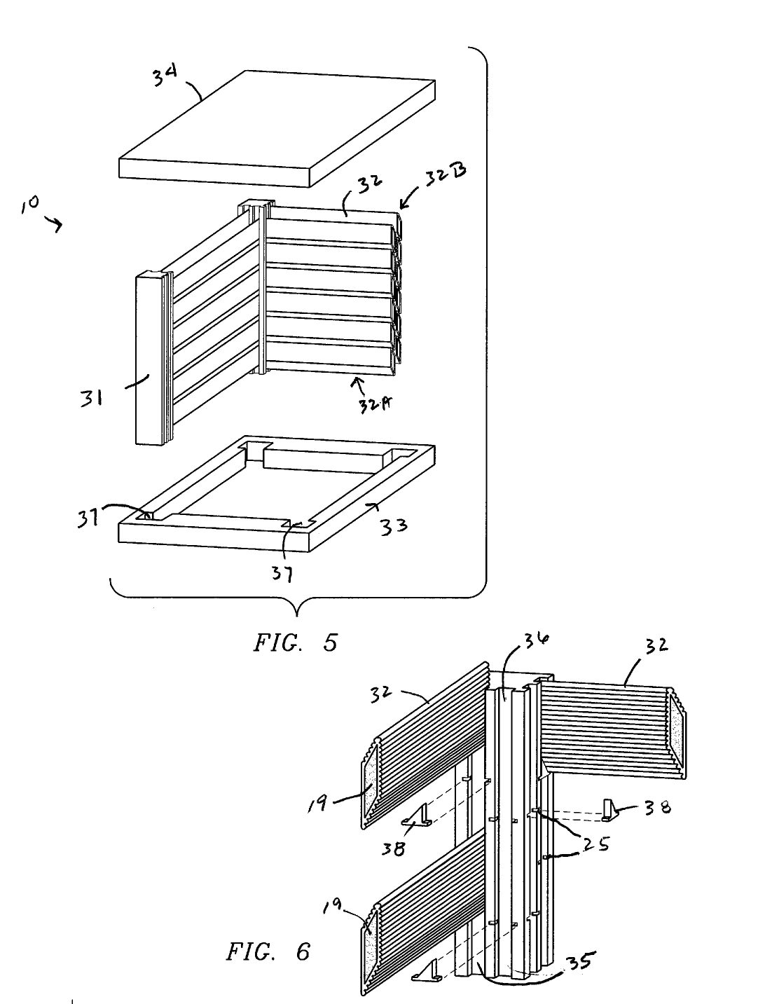

A second embodiment of the enclosure 10 illustrated in FIGS. 5, 6 and 7, includes panels 32 supported in spaced relation to one another by columns 31. The panels 32 include a first set 32A and a second set 32B spaced laterally from the first set 32A toward an exterior of the enclosure. In each set 32A and 32B, adjacent panels 32 are spaced apart forming a gap 33 between consecutive panels 32. However, the panels 32 in the first set 32A are positioned with respect to the panels 32 of the second set 32B so that the first set 32A covers at least a portion of the gaps 33 between consecutive panels 32 in the second set 32B. Similarly, the second set 32B is positioned with respect to the first set of panels 32A so that second set of panels 32B covers at least a portion of the gaps 33 between consecutive panels in the second set 32B.

The panels 32 shown in FIG. 7 have the inclined sections 15 and 16 as in the above-described first embodiment. However, other shapes may be used. For example panels 32 may have a rectangular cross-sectional configuration having an inner chamber 22 that is filled with a sound retardant material 19. In such a case a portion of one of panels 32 covers the gap 33 between two laterally disposed panels of the other set.

With respect to FIGS. 5 and 6, the connection of the panels 32 to the columns 31 is illustrated. In this second embodiment, the enclosure 10 includes four columns 31 secured to a base 33. The base 33 is rectangular and has a notch 37 disposed in each of the four corners of the base for receiving a column 31. While this embodiment has a rectangular configuration, the invention is not so limited and may include any type of configuration necessary to form an enclosure. Each of the columns 31 includes a first channel 35 and a second channel 36 that is parallel to the first channel 35 for receiving the ends of the panels 32. Spacers 38, secured within notches 25 in the channels 35 and 36, support the panels 32 on the columns 31. The columns 31 are vertically disposed and each end of a panel 32 is inserted within a channel 35 or 36 on a respective column 31. The panels 32 are disposed horizontally between the columns 31. Although the embodiment describe herein shows the panels 32 disposed horizontally, and the columns 31 disposed vertically, the enclosure 10 could be arranged so that columns 31 are disposed horizontally and the panels 32 are disposed vertically.

The base 33 is not required to form the enclosure 30. That is, the columns 31 may be free standing without the aid of the base 33. In addition, the method or means for securing the panels 32 to the columns 31 is not limited to the elongated channel 24, but may include other securing means. For example, the columns may have holes spaced vertically and laterally on the column for receiving the ends of the panels 32. Alternatively, fastening mechanism as nails, bolts, clamps etc. may be used to secure the panels 32 to columns 31.

The enclosure 10 of the second embodiment may also include one or more apertures (not shown) similar to the above-described first embodiment to allow parts to protrude out of the enclosure 10.

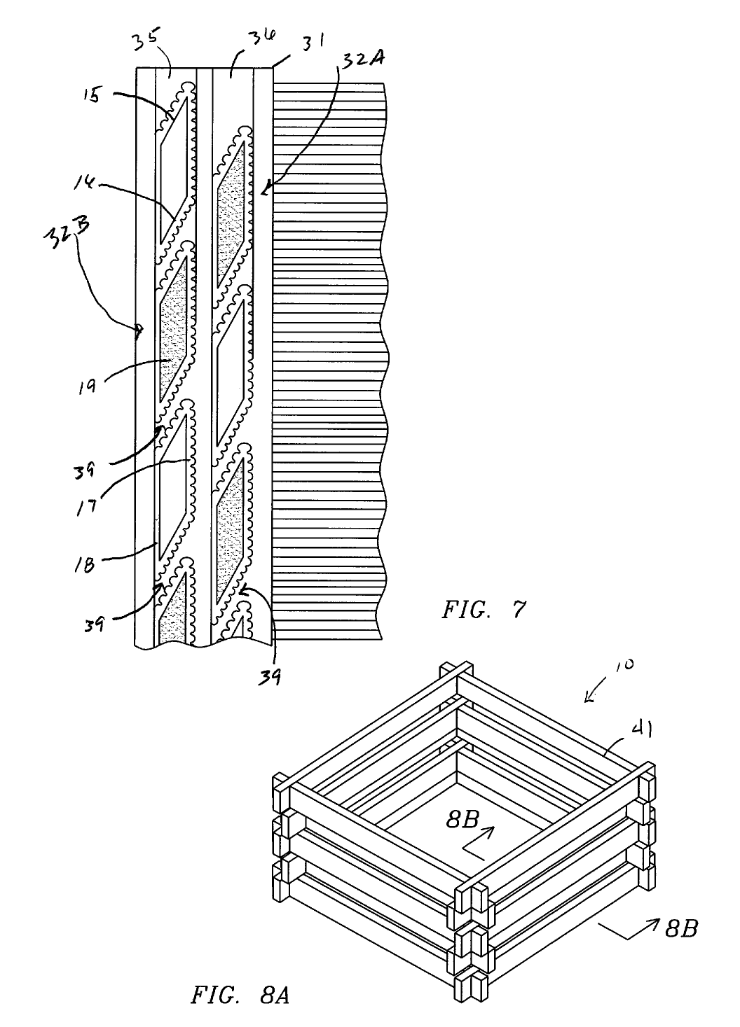

A third embodiment of the enclosure is illustrated in FIGS. 8A, 8B, 9 and 10, also includes a similar “staggered” panel configuration as in the second embodiment; however, columns are not necessary to arrange the panels to form an enclosure. More specifically, the enclosure 10 includes panels 41 including a first set of panels 41A and a second set of panels 41B. The first set of panels 41A includes a plurality panels that are spaced apart forming a gap 43 between each consecutive pair of panels 41. The second set of panels 41B are laterally spaced from the first set of panels 41A toward an exterior of the enclosure 40. Panels from the first set 41A cover at least a portion of the gaps 43 between the panels of the second set 41B; and, panels from the second set 41B cover at least a portion of the gaps 43 between the panels of the first set 41A.

As shown in FIG. 9, the panels of the first set 41A and second set 41B are the same length. Two notches 44 are formed in each panel 41 of the first set of panels 41A; and, two notches 45 are formed in each panel of the second set of panels 41B. The notches 44 and 45 enable the panels 41 to interlock as shown in FIG. 7. The notches 44 on panel of the first set 41A are spaced apart D1, and the notches 45 in the second set of panels 41B are spaced a distance D2 which is greater than the distance D1. Accordingly, four panels 41 of the first set 41A make a rectangle that has a diameter that is smaller in diameter of the rectangle made from the second set 41B of panels 41. When the first set of panels 41B are stacked on the second set of panels 41B, and vice versa, the panels 41A and 41B are displaced laterally with respect to one another.

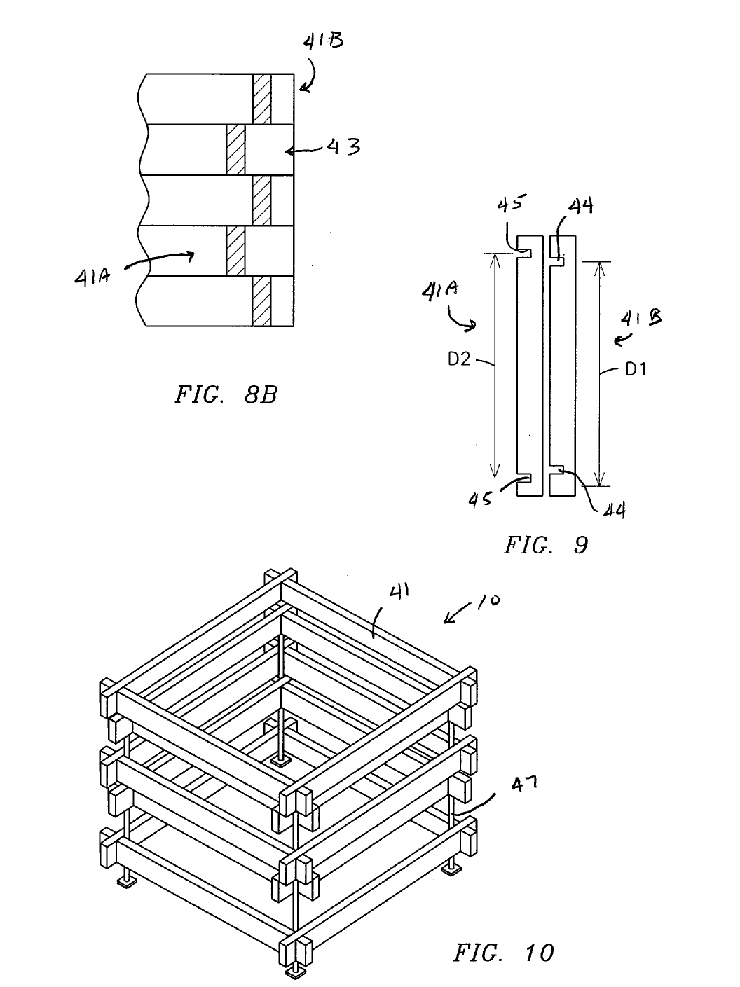

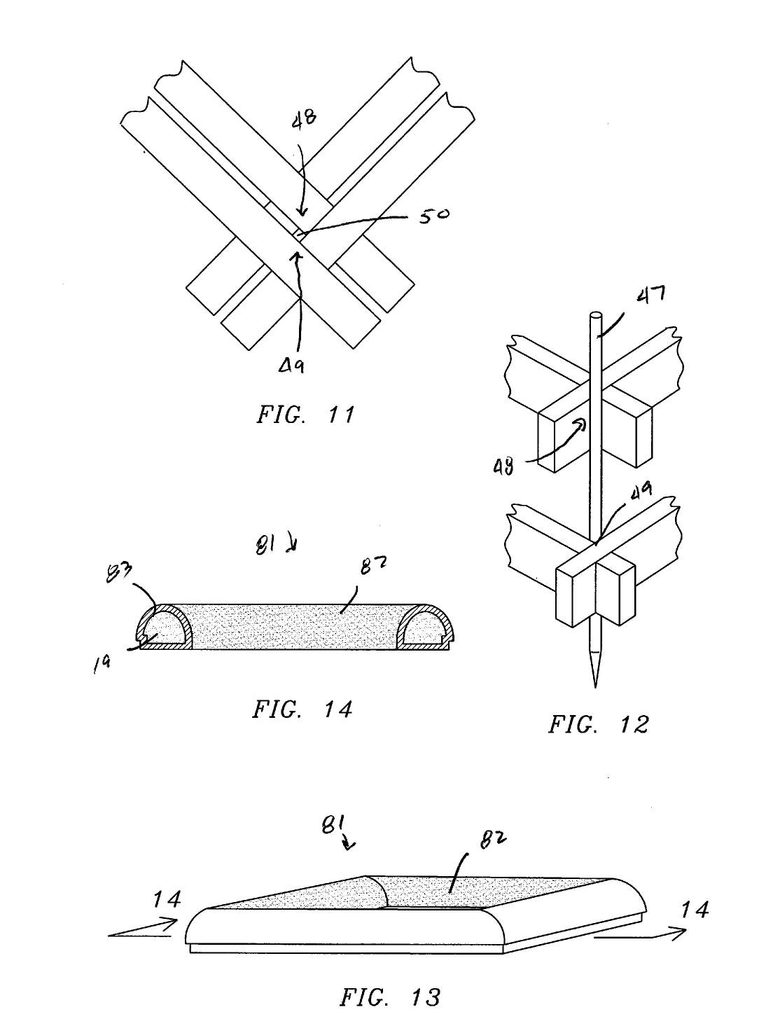

With respect to FIGS. 10, 11 and 12, there is illustrated a support rod 47 positioned at each of the corners of the enclosure 10. More specifically, when the panels 41 are stacked atop one another the corner 48 on the first set of panels 41A is disposed laterally inward, or toward an interior of the enclosure 10 with respect to a corner 49 on the second set of panels 41B, thereby forming hole 50 between consecutive levels of the panels 41 and at the corner 48 and 49 of each level. The rod 47 is inserted in the hole 50 to stabilize the panels 41.

The enclosure 10 of the third embodiment may also include one or more apertures (not shown) similar to the above-described first embodiment to allow parts to protrude out of the enclosure 10.

In an embodiment shown in FIGS. 13 and 14 a grommet 62 is positioned within an aperture 84 (represented by the dotted line in FIG. 14) to seal an interface between a pipe 63 and the enclosure 10. In this embodiment, the enclosure 10 includes an assembly 61, including the grommet 62, mounted on the enclosure 10. Two panels 64, that may be shorter than other panels (not shown), are aligned end-to-end and spaced apart forming a gap 67 within which the assembly 61, including the grommet 62, is mounted. As shown in FIG. 13, the assembly 61 may include separable members 65 (first member) and 66 (second member) configured to fit within the gap 67 and in mating relationship with each of the panels 64. The assembly 61, shown in FIGS. 13 and 14, is positioned at the base of the enclosure 10; however, the gap 64 and the assembly 61 may be located anywhere on the enclosure 10 where a component of the operating system protrudes from the enclosure.

In practice of each of the above-described embodiments, the components of the enclosure including the panels 64 and columns 69, if the enclosure includes columns 69, is transported to the site of the operating system. The grommet 62 is attached to the pipe 63 preferably before the installation of panels 64. The grommet 62 may be fabricated from a rubber material having a slit 68 and is flexible enough to open the grommet 62 sufficiently to receive the pipe 63. The first member 65 is preferably positioned underneath the pipe 63, then the panels 64 are installed forming gap 67 through which the pipe 63 extends. The second member 66 is then installed on top of the grommet 62 and pipe 63 as shown in FIGS. 13 and 14. In the above-described embodiments in which the panels 64 may be spaced apart, an additional support mechanism may be required between consecutively spaced panels. Alternatively, one or more of the panels in each of the above-described panels may be prefabricated with the gap 67 formed in the panels for receiving the pipe 63 and grommet assembly 61.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

I claim as my invention:

1. A sound attenuation enclosure, comprising:
a plurality of sound insulating panels; and,
a plurality of support columns wherein each of the panels has a first end attached to a support column and a second end attached to another column, wherein at least two of the panels are supported side by side and in spaced relation to one another, and the plurality of panels are arranged to form an enclosure.

2. The invention of claim 1 wherein one or more of the panels has an enclosed inner chamber and a sound retardant material is disposed within the inner chamber of the panel.

3. The invention of claim 1 further comprising means, on an interior surface of one or more of the panels, for attenuating sound emanating from an operating device positioned with the enclosure.

4. The invention of claim 3 wherein the sound attenuating means includes a plurality of cavities and protrusions formed on the interior surface of the one or more panels.

5. The invention of claim 1 wherein each of the at least two panels includes a top section positioned parallel to a bottom section, two side sections parallel to one another and disposed between the top section and the side section, and the top section and bottom section are disposed at an angle less than ninety degrees with respect to one of the side sections and the top section of one panel overlaps the bottom section of the other panel.

6. The invention of claim 5 wherein the top section and bottom section on the panels are disposed at an angle of about forty-five degrees with respect to one of the side sections.

7. The invention of claim 1 further comprising a cover positioned on a top of the enclosure.

8. The invention of claim 1 wherein the support columns are vertically disposed and spaced apart from one another and each of the panels is disposed horizontally between the panels, supported therein and forming the enclosure and the panels are detachable from the support columns so the enclosure is transportable.

9. The invention of claim 8 further comprising a base supporting the columns in a vertically disposed position, and each of the panels is horizontally disposed between the columns forming the enclosure and a cover is positioned on a top of the enclosure.

10. A sound attenuation enclosure, comprising:
a plurality of sound insulating panels;
a plurality of support columns wherein each of the panels has a first end attached to a support column and a second end attached to another column wherein at least two of the panels are supported side by side and in spaced relation to one another, and the at least two panels are aligned with respect to one another such that a bottom section of one panel overlaps a top section of the other panel, and the plurality of panels are arranged to form an enclosure.

11. The invention of claim 10 wherein one or more of the panels has an enclosed inner chamber and a sound retardant material is disposed within the inner chamber of the panel.

12. The invention of claim 10 further comprising means, on an interior surface of one or more of the panels, for attenuating sound emanating from an operating device positioned with the enclosure.

13. The invention of claim 12 wherein the sound attenuating means includes a plurality of cavities and protrusions formed on the interior surface of the one or more panels.

14. The invention of claim 10 wherein each of the panels is formed through extrusion of a desired material and the sound attenuation means includes a plurality of adjacent elongated cavities and ridges integrally formed in the surface of each of the panels.

15. The invention of claim 10 wherein each of the at least two panels includes a top section positioned parallel to a bottom section, two side sections parallel to one another and disposed between the top section and the side section, and the top section and bottom section are disposed at an angle less than ninety degrees with respect to one of the side sections and the top section of one panel overlaps the bottom section of the other panel.

16. The invention of claim 15 wherein the top section and bottom section on the panels are disposed at an angle of about forty-five degrees with respect to one of the side sections.

17. The invention of claim 10 further comprising a cover positioned on a top of the enclosure.

18. The invention of claim 10 wherein the support columns are vertically disposed and spaced apart from one another and each of the panels is disposed horizontally between the panels, supported therein and forming the enclosure and the panels are detachable from the support columns so the enclosure is transportable.

19. The invention of claim 10 wherein the plurality of panels comprises a first set of panels and a second set of panels wherein the panels within the first set of panels are aligned side by side in spaced relation to one another forming a gap between adjacent panels, and the panels within the second set of panels are aligned side by side in spaced relation to one another forming a gap between adjacent panels, and the first set of panels is spaced laterally with respect to the second set of panels toward an interior of the enclosure, and one or more of the panels within the first set of panels covers a gap between adjacent panels in the second set of panels and one or more of the panels within the second set of panels covers a gap between adjacent panels in the first set of panels.

20. The invention of claim 19 wherein the first set of panels are arranged in a plurality spaced apart levels and each level having an equal first diameter and the second set of panels are arranged in a plurality levels and each level having an equal second diameter that is greater than the first diameter and the levels are stacked in alternating sequence.

21. A sound attenuation enclosure, comprising:
a plurality of sound insulating panels, and each of the panels having an enclosed chamber filled with a sound retardant material;
a plurality of support columns supporting the panels wherein each of the panels is supported in spaced relation to an adjacent panel, and the plurality of panels are arranged to form an enclosure.

22. The invention of claim 21 wherein a top section or bottom section of each panel overlaps a top section or bottom section of an adjacent panel.

23. The invention of claim 21 wherein the plurality of panels comprises a first set of panels and a second set of panels wherein the panels within the first set of panels are aligned side by side in spaced relation to one another forming a gap between adjacent panels, and the panels within the second set of panels are aligned side by side in spaced relation to one another forming a gap between adjacent panels, and the first set of panels is spaced laterally with respect to the second set of panels toward an interior of the enclosure, and one or more of the panels within the first set of panels covers a gap between adjacent panels in the second set of panels and one or more of the panels within the second set of panels covers a gap between adjacent panels in the first set of panels.

24. The invention of claim 22 wherein the first set of panels are arranged in a plurality spaced apart levels and each level having an equal first diameter and the second set of panels are arranged in a plurality levels and each level having an equal second diameter that is greater than the first diameter and the levels are stacked in alternating sequence.

25. The invention of claim 24 further comprising one or more support rods disposed between the first set of panels and the second set of panels.
